(19) United States
(12) Patent Application Publication
(10) Pub. No.: US 2024/0176585 A1
(43) Pub. Date: May 30, 2024

(54) DATA PROCESSING METHOD, COMPUTER DEVICE AND STORAGE MEDIUM

(71) Applicant: Glenfly Tech Co., Ltd., Shanghai (CN)

(72) Inventors: Yaohui ZENG, Shanghai (CN); Renyu BIAN, Shanghai (CN); Huaisheng ZHANG, Shanghai (CN)

(21) Appl. No.: 18/225,467

(22) Filed: Jul. 24, 2023

(30) Foreign Application Priority Data
Nov. 30, 2022 (CN) 202211519633.4

(51) Int. Cl. G06F 7/523; G06F 7/36

(52) U.S. Cl. CPC G06F 7/523; G06F 7/36

(57) ABSTRACT

The present application relates to a data processing method, a computer device, and a storage medium. The method includes: acquiring data formats of two pieces of input data; the data formats of the two pieces of input data being the same; determining a target data conversion algorithm matching the data formats from a plurality of preset data conversion algorithms, and performing, by using the target data conversion algorithm, data format conversion on the two pieces of input data to obtain at least two pieces of target input data; processing, by using a multiplier, the at least two pieces of target input data to obtain a preliminary operation result; and determining truncation bit widths corresponding to the two pieces of input data, and processing the preliminary operation result according to the truncation bit widths, to obtain a multiplication operation result corresponding to the two pieces of input data.

### CROSS REFERENCE TO RELATED APPLICATIONS

This application claims all benefits accruing under 35 U.S.C. § 119 to Chinese Patent Applications No. 202211519633.4 filed on Nov. 30, 2022 in the China National Intellectual Property Administration, the content of which is hereby incorporated by reference.

### TECHNICAL FIELD

The present application relates to the field of digital circuit technologies, and in particular, to a data processing method, a computer device, a storage medium, and a multiplier structure.

### BACKGROUND

A multiplier is an important part of an arithmetic unit of a processor chip, and a design thereof is relatively complicated, which may consume more chip areas. The multiplier in the chip is required to meet calculation requirements of various types of values. Different multipliers are generally required to be designed for different calculation requirements, thereby consuming the chip areas to varying degrees. Among various numerical operations in the processor chip, a multiplication operation consumes relatively more resources. At the same time, modern processor cores generally process numerical operations in multiple formats instead of a single format. This requires providing a multiplier for a value in each format, which may take up a large chip area and result in high device resource consumption.

A current chip is required to process multiple formats of operations at the same time, and different multipliers are required to be respectively designed for different operations. A large number of multipliers occupy a large number of device resources, resulting in high resource consumption.

### SUMMARY

Based on this, there is a need to provide a data processing method, a computer device, a storage medium, and a multiplier structure that can reduce device resource consumption with respect to the above technical problems.

In a first aspect, the present application provides a data processing method. The method includes:
acquiring data formats of two pieces of input data; the data formats of the two pieces of input data being the same;
determining a target data conversion algorithm matching the data formats from a plurality of preset data conversion algorithms, and performing, by using the target data conversion algorithm, data format conversion on the two pieces of input data to obtain at least two pieces of target input data;
processing, by using a multiplier, the at least two pieces of target input data to obtain a preliminary operation result; and
determining truncation bit widths corresponding to the two pieces of input data, and processing the preliminary operation result according to the truncation bit widths, to obtain a multiplication operation result corresponding to the two pieces of input data.

In an embodiment, the plurality of preset data conversion algorithms are acquired by:
determining a target data format; and
determining, according to a conversion relationship between each data format and the target data format, a data conversion algorithm for converting each data format into the target data format, to obtain the plurality of preset data conversion algorithms for different data formats; and
the multiplier is acquired by:
determining an adaptive multiplier according to the target data format.

In an embodiment, the performing, by using the target data conversion algorithm, data format conversion on the two pieces of input data to obtain at least two pieces of target input data includes:
acquiring data bit widths of the two pieces of input data, and acquiring an input bit width of the multiplier;
splitting each piece of input data into a plurality of pieces of sub-data if the data bit widths of the two pieces of input data are greater than the input bit width of the multiplier; each of data bit widths of the plurality of pieces of sub-data being less than the input bit width of the multiplier; and
performing, by using the target data conversion algorithm, data format conversion on the plurality of pieces of sub-data to obtain a plurality of pieces of target input data.

In an embodiment, processing, by using the multiplier, the at least two pieces of target input data to obtain the preliminary operation result includes:
arranging and combining each piece of target input data corresponding to one of the two pieces of input data with each piece of target input data corresponding to the other of the two pieces of input data to obtain a plurality of target input data pairs; and
inputting the plurality of target input data pairs respectively into the multiplier to obtain a plurality of output results outputted by the multiplier, and taking the plurality of output results as the preliminary operation result; each of the output results corresponding to each of the target input data pairs.

In an embodiment, determining truncation bit widths corresponding to the two pieces of input data, and processing the preliminary operation result according to the truncation bit widths, to obtain a multiplication operation result corresponding to the two pieces of input data includes:
determining a packet truncation bit width according to data bit widths of two pieces of target input data in each of the target input data pairs as the truncation bit widths corresponding to the two pieces of input data to obtain a plurality of packet truncation bit widths for the plurality of target input data pairs;
performing low-bit truncation and reservation on each output result corresponding to each target input data pair in the preliminary operation result according to each of the packet truncation bit widths corresponding to the same target input data pair respectively; and
accumulating output results after the low-bit truncation and reservation to obtain the multiplication operation result corresponding to the two pieces of input data.

In an embodiment, performing, by using the target data conversion algorithm, data format conversion on the two pieces of input data to obtain at least two pieces of target input data further includes:
performing, by using the target data conversion algorithm, data format conversion on the two pieces of input data respectively to obtain two pieces of target input data if the data bit widths of the two pieces of input data are no greater than the input bit width of the multiplier.

In an embodiment, processing, by using the multiplier, the at least two pieces of target input data to obtain the preliminary operation result further includes:
inputting the two pieces of target input data into the multiplier to obtain one output result outputted by the multiplier, and taking the output result as the preliminary operation result.

In an embodiment, determining truncation bit widths corresponding to the two pieces of input data, and processing the preliminary operation result according to the truncation bit widths, to obtain a multiplication operation result corresponding to the two pieces of input data further includes:
adding the data bit widths of the two pieces of input data to obtain the truncation bit widths corresponding to the two pieces of input data; and
performing low-bit truncation and reservation on the preliminary operation result according to the truncation bit widths, to obtain the multiplication operation result corresponding to the two pieces of input data.

In an embodiment, the method further includes:
determining sign types of the two pieces of input data; the sign types being classified into a signed type and an unsigned type;
configuring the multiplier according to the sign types of the two pieces of input data; and
processing, by using a multiplier, the at least two pieces of target input data to obtain a preliminary operation result; and

In an embodiment, the configuring the multiplier according to the sign types of the two pieces of input data includes:
configuring the multiplier as a signed multiplier if one of the two pieces of input data is of the signed type; and
configuring the multiplier as an unsigned multiplier if both the two pieces of input data are of the unsigned type.

In a second aspect, the present application further provides a multiplier structure. The multiplier structure includes:
a format conversion unit configured to input two pieces of input data, acquire data formats of the two pieces of input data, determine a target data conversion algorithm matching the data formats from a plurality of preset data conversion algorithms, perform, by using the target data conversion algorithm, data format conversion on the two pieces of input data to obtain at least two pieces of target input data, and input the at least two pieces of target input data into a multiplier; the data formats of the two pieces of input data being the same;
the multiplier configured to process the at least two pieces of target input data to obtain a preliminary operation result; and
a result processing unit configured to determine truncation bit widths corresponding to the two pieces of input data, and process the preliminary operation result according to the truncation bit widths, to obtain a multiplication operation result corresponding to the two pieces of input data.

In a third aspect, the present application further provides a computer device. The computer device includes a memory and a processor, the memory storing a computer program, wherein the processor, when executing the computer program, implements the following steps:
acquiring data formats of two pieces of input data; the data formats of the two pieces of input data being the same;
determining a target data conversion algorithm matching the data formats from a plurality of preset data conversion algorithms, and performing, by using the target data conversion algorithm, data format conversion on the two pieces of input data to obtain at least two pieces of target input data;
processing, by using a multiplier, the at least two pieces of target input data to obtain a preliminary operation result; and
determining truncation bit widths corresponding to the two pieces of input data, and processing the preliminary operation result according to the truncation bit widths, to obtain a multiplication operation result corresponding to the two pieces of input data.

In a fourth aspect, the present application further provides a computer-readable storage medium. The computer-readable storage medium stores a computer program, wherein, when the computer program is executed by a processor, the following steps are implemented:
acquiring data formats of two pieces of input data; the data formats of the two pieces of input data being the same;
determining a target data conversion algorithm matching the data formats from a plurality of preset data conversion algorithms, and performing, by using the target data conversion algorithm, data format conversion on the two pieces of input data to obtain at least two pieces of target input data;
processing, by using a multiplier, the at least two pieces of target input data to obtain a preliminary operation result; and
determining truncation bit widths corresponding to the two pieces of input data, and processing the preliminary operation result according to the truncation bit widths, to obtain a multiplication operation result corresponding to the two pieces of input data.

In a fifth aspect, the present application further provides a computer program product. The computer program product includes a computer program, wherein, when the computer program is executed by a processor, the following steps are implemented:
acquiring data formats of two pieces of input data; the data formats of the two pieces of input data being the same;
determining a target data conversion algorithm matching the data formats from a plurality of preset data conversion algorithms, and performing, by using the target data conversion algorithm, data format conversion on the two pieces of input data to obtain at least two pieces of target input data;
processing, by using a multiplier, the at least two pieces of target input data to obtain a preliminary operation result; and
determining truncation bit widths corresponding to the two pieces of input data, and processing the preliminary operation result according to the truncation bit widths, to obtain a multiplication operation result corresponding to the two pieces of input data.

According to the data processing method, the computer device, the storage medium, and the multiplier structure described above, data formats of two pieces of input data are acquired; the data formats of the two pieces of input data are the same; a target data conversion algorithm matching the data formats is determined from a plurality of preset data conversion algorithms, and data format conversion is performed, by using the target data conversion algorithm, on the two pieces of input data to obtain at least two pieces of target input data; the at least two pieces of target input data are processed, by using a multiplier, to obtain a preliminary operation result; and truncation bit widths corresponding to the two pieces of input data are determined, and the preliminary operation result is processed according to the truncation bit widths, to obtain a multiplication operation result corresponding to the two pieces of input data. Resource consumption of a device for processing a multiplication operation can be reduced, thereby improving performance of the device.

### BRIEF DESCRIPTION OF THE DRAWINGS

FIG. 1 is a schematic flowchart of a data processing method according to an embodiment;

FIG. 2 is a schematic diagram of a format of a half-precision floating-point number according to an embodiment;

FIG. 3 is a schematic diagram of a format of a single-precision floating-point number according to an embodiment;

FIG. 4 is a schematic diagram of a format of a signed half-precision floating-point integer according to an embodiment;

FIG. 5 is a schematic diagram of a format of an unsigned half-precision floating-point integer according to an embodiment;

FIG. 6 is a schematic diagram of a format of a signed single-precision floating-point integer according to an embodiment;

FIG. 7 is a schematic diagram of a format of an unsigned single-precision floating-point integer according to an embodiment;

FIG. 8 is a schematic diagram of a format of a signed 24-bit integer according to an embodiment;

FIG. 9 is a schematic diagram of a format of an unsigned 24-bit integer according to an embodiment;

FIG. 10 is a schematic flowchart of single-precision integer multiplication according to an embodiment;

FIG. 11 is a schematic split diagram of a single-precision number according to an embodiment;

FIG. 12 is a schematic diagram of a processing result of Part A according to an embodiment;

FIG. 13 is a schematic diagram of a processing result of Part B according to an embodiment;

FIG. 14 is a schematic diagram of accumulation positions of 4 multiplication operation results according to an embodiment;

FIG. 15 is a schematic diagram of a processing result of a half-precision floating-point number according to an embodiment;

FIG. 16 is a schematic diagram of a processing result of a single-precision floating-point number according to an embodiment;

FIG. 17 is a schematic diagram of a processing result of a half-precision signed integer according to an embodiment;

FIG. 18 is a schematic diagram of a processing result of a half-precision unsigned integer according to an embodiment;

FIG. 19 is a structural block diagram of a multiplier structure according to an embodiment; and

FIG. 20 is a diagram of an internal structure of a computer device according to an embodiment.

### DETAILED DESCRIPTION OF THE EMBODIMENTS

In order to make the above objectives, technical solutions, and advantages of the present application more obvious and understandable, the present application is described in detail below with reference to the accompanying drawings and embodiments. It should be understood that specific embodiments described herein are intended only to explain the present application, and are not intended to limit the present application.

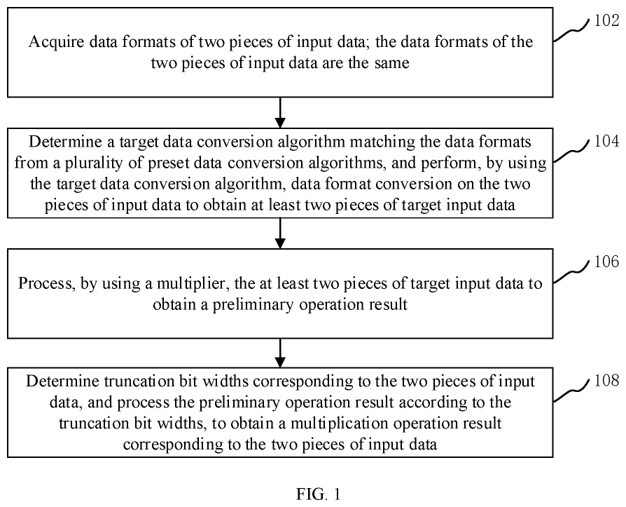

In an embodiment, as shown in FIG. 1, a data processing method is provided. This embodiment is described with an example in which the method is applied to a computer device. It may be understood that the computer device may specifically be a terminal or a server. The terminal may be, but is not limited to, various personal computers, laptop computers, smart phones, tablet computers, Internet of Things devices, and portable wearable devices. The Internet of Things devices may be smart speakers, smart TVs, smart air conditioners, smart medical devices, or the like. The portable wearable devices may be smart watches, smart bracelets, headset devices, or the like. The server may be implemented by a standalone server or a server cluster formed by a plurality of servers. In this embodiment, the method includes the following steps.

In step 102, data formats of two pieces of input data are acquired; and the data formats of the two pieces of input data are the same.

The data formats include, but are not limited to, a half-precision floating-point number, a single-precision floating-point number, a half-precision integer, a single-precision integer, and a 24-bit integer. If a sign bit is considered, the half-precision integer may further be divided into a signed half-precision integer and an unsigned half-precision integer, the single-precision integer may further be divided into a signed single-precision integer and an unsigned single-precision integer, and the 24-bit integer may further be divided into a signed 24-bit integer and an unsigned 24-bit integer.

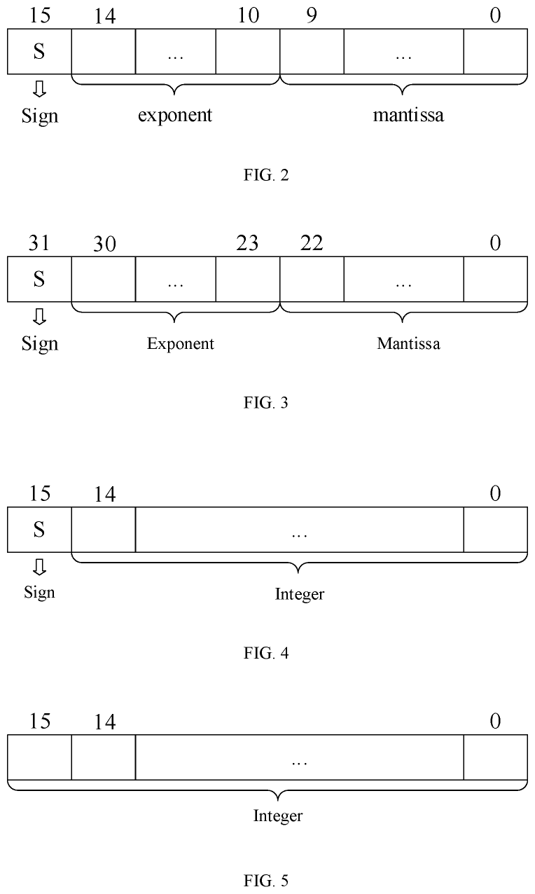

A standardized half-precision floating-point number is formed by 16-bit binary data, and is in a data format shown in FIG. 2.

S denotes a sign bit, S=0 means that data is positive, and S=1 means that data is negative.

Exponent denotes an exponent part, which is 5-bit binary data.

Mantissa denotes a fractional part, which is 10-bit binary data.

Normal means that the exponent of the floating-point number is not all 1 and not all 0, and the number 1 before the decimal point is omitted.

Denormal means that the exponent of the floating-point number is all 0, the mantissa is not all 0, and the number 0 before the decimal point is omitted.

Exponent bias: bias=0xF for Normal data, bias=0xE for Denormal data.

A value represented by half-precision floating-point Normal data is data=(−1)^{S}*2^{exponent=0xF}*(1.mantissa)

A value represented by half-precision floating-point Denormal data is data=(−1)S*2^{exponent=0xE}*(0).mantissa)

A standardized single-precision floating-point number is formed by 32-bit binary data, and is in a data format shown in FIG. 3.

S denotes a sign bit, S=0 means that data is positive, and S=1 means that data is negative.

Exponent denotes an exponent part, which is 8-bit binary data.

Mantissa denotes a fractional part, which is 23-bit binary data.

Exponent bias: bias=0x7F for Normal data, bias=0x7E for Denormal data.

A value represented by single-precision floating-point Normal data is data=(−1)S*2^{exponent=0x7F}*(1.mantissa).

A value represented by single-precision floating-point Denormal data is data=(−1)S*2^{exponent=0x7E}*(0.mantissa).

The half-precision integer is formed by 16-bit binary data. When the integer is a signed integer, the highest bit is a sign bit, and the rest are an integer part. A data format is shown in FIG. 4. When the integer is an unsigned integer, all are an integer part, and a data format is as shown in FIG. 5.

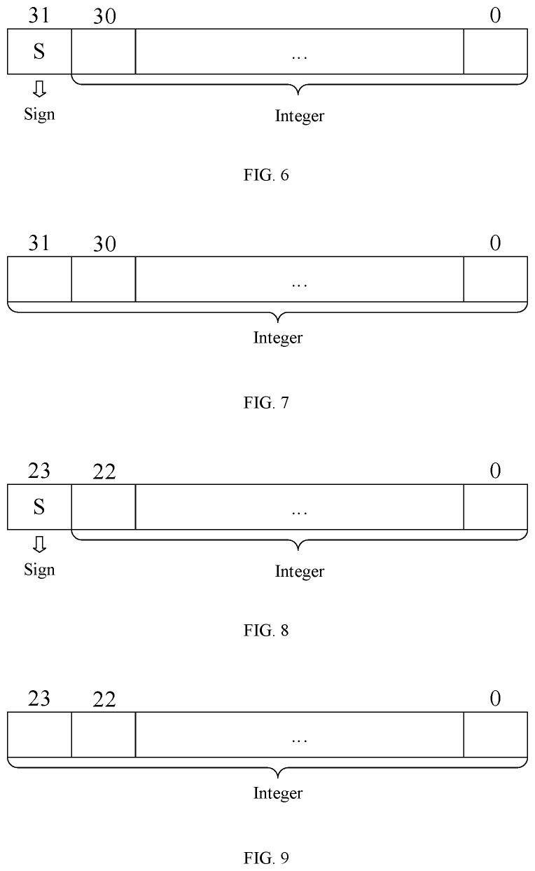

The single-precision integer is formed by 32-bit binary data. When the integer is a signed integer, the highest bit is a sign bit, and the rest are an integer part. A data format is shown in FIG. 6. When the integer is an unsigned integer, all are an integer part, and a data format is as shown in FIG. 7.

The 24-bit integer is formed by 24-bit binary data. When the integer is a signed integer, the highest bit is a sign bit, and the rest are an integer part. A data format is shown in FIG. 8. When the integer is an unsigned integer, all are an integer part, and a data format is as shown in FIG. 9.

Optionally, the computer device recognizes the data formats of the two pieces of input data, and if the data formats of the two pieces of input data are the same, the computer device determines that current input data meets a multiplication operation condition, and subsequent processing steps are performed. If the data formats of the two pieces of input data recognized by the computer device are different, it is determined that the current input data cannot meet the multiplication operation condition, the subsequent processing steps may not be performed, and prompt information indicating that the data formats are inconsistent is generated.

In step 104, a target data conversion algorithm matching the data formats is determined from a plurality of preset data conversion algorithms, and data format conversion is performed, by using the target data conversion algorithm, on the two pieces of input data to obtain at least two pieces of target input data.

Optionally, the computer device selects, from the plurality of preset data conversion algorithms, a target data conversion algorithm matching the data format of the input data, and performs, by using the target data conversion algorithm, data format conversion on the two pieces of input data to obtain two pieces of target input data. The target data conversion algorithm can convert the input data from an original data format into a target data format, so that input data in any format can be converted into a unified target data format, which is convenient for the subsequent multiplication operation. For example, the target data format is a 24-bit integer, and the data formats of the two pieces of input data are a single-precision floating-point number. The computer device selects a data conversion algorithm that can convert the single-precision floating-point number into the 24-bit integer as the target data conversion algorithm. The two pieces of input data are respectively converted into the data format of the 24-bit integer, and the two 24-bit integers are used as the target input data.

In step 106, the at least two pieces of target input data are processed by using a multiplier, to obtain a preliminary operation result.

Optionally, the computer device uses the multiplier to perform a multiplication operation on the two pieces of target input data to obtain the preliminary operation result. Since the input data in any data format has been converted into the target data format, the multiplication operation on the input data can be realized only by using a multiplier in one data format. For example, the target data format is a 24-bit integer, and only a 24-bit integer multiplier is required to be provided. Input data of any data format is firstly converted into a 24-bit integer and then multiplied by using the 24-bit integer multiplier.

In step 108, truncation bit widths corresponding to the two pieces of input data are determined, and the preliminary operation result is processed according to the truncation bit widths, to obtain a multiplication operation result corresponding to the two pieces of input data.

Optionally, the computer device recognizes data bit widths of the two pieces of input data, determines the data bit widths after multiplication of the two as the truncation bit widths based on input bit widths of the input data, and then perform low-bit truncation and reservation on the preliminary operation result according to the truncation bit widths as a final multiplication operation result of the two pieces of input data.

In the above data processing method, data formats of two pieces of input data are acquired; the data formats of the two pieces of input data are the same; a target data conversion algorithm matching the data formats is determined from a plurality of preset data conversion algorithms, and data format conversion is performed, by using the target data conversion algorithm, on the two pieces of input data to obtain at least two pieces of target input data; the at least two pieces of target input data are processed, by using a multiplier, to obtain a preliminary operation result; and truncation bit widths corresponding to the two pieces of input data are determined, and the preliminary operation result is processed according to the truncation bit widths, to obtain a multiplication operation result corresponding to the two pieces of input data. Resource consumption of a device for processing a multiplication operation can be reduced, thereby improving performance of the device.

In an embodiment, the plurality of preset data conversion algorithms are acquired by: determining a target data format; and determining, according to a conversion relationship between each data format and the target data format, a data conversion algorithm for converting each data format into the target data format, to obtain the plurality of preset data conversion algorithms for different data formats. The multiplier is acquired by determining an adaptive multiplier according to the target data format.

Optionally, the 24-bit integer can be used as the target data format, the plurality of preset data conversion algorithms are obtained according to a conversion relationship between the half-precision floating-point number and the 24-bit integer, a conversion relationship between the single-precision floating-point number and the 24-bit integer, a conversion relationship between the half-precision integer and the 24-bit integer, and a conversion relationship between the single-precision integer and the 24-bit integer, and a 24-bit integer multiplier is configured.

In this embodiment, the target data format is determined, and the data conversion algorithm for converting each data format into the target data format is determined according to the conversion relationship between each data format and the target data format, to obtain the plurality of preset data conversion algorithms for different data formats. Data in a variety of different data formats can be converted into data in a same data format, so that multiplication operations in different data formats can be processed only by using one adaptive multiplier.

In an embodiment, sign types of the two pieces of input data are determined, and the sign types are classified into a signed type and an unsigned type. The multiplier is configured as a signed multiplier if one of the two pieces of input data is of the signed type. The multiplier is configured as an unsigned multiplier if both the two pieces of input data are of the unsigned type. The at least two pieces of target input data are processed by using the configured multiplier, to obtain the preliminary operation result.

Optionally, the sign types of the two pieces of input data can be determined according to sign bits of the two pieces of input data. Firstly, an adaptive multiplier is selected according to the determined target data format. Then, the adaptive multiplier is configured as a signed or unsigned mode according to the sign types of the two pieces of input data. For example, if the 24-bit integer is used as the target data format, a 24-bit integer multiplier is configured. The 24-bit integer multiplier is configured as the signed mode if either of the two pieces of input data is of the signed type. The 24-bit integer multiplier is configured as the unsigned mode if both the two pieces of input data are of the unsigned type.

In this embodiment, sign types of the two pieces of input data are determined, and the sign types are classified into a signed type and an unsigned type. The multiplier is configured according to the sign types of the two pieces of input data. The at least two pieces of target input data are processed by using the configured multiplier, to obtain the preliminary operation result. Only one multiplier matching the target data format can be configured, which reduces resource consumption of the multiplier in the computer device, thereby improving performance of the device.

In an embodiment, the performing, by using the target data conversion algorithm, data format conversion on the two pieces of input data to obtain at least two pieces of target input data includes: acquiring data bit widths of the two pieces of input data, and acquiring an input bit width of the multiplier; splitting each piece of input data into a plurality of pieces of sub-data if the data bit widths of the two pieces of input data are greater than the input bit width of the multiplier; each of data bit widths of the plurality of pieces of sub-data being less than the input bit width of the multiplier; and performing, by using the target data conversion algorithm, data format conversion on the plurality of pieces of sub-data to obtain a plurality of pieces of target input data.

Further, the processing, by using a multiplier, the at least two pieces of target input data to obtain a preliminary operation result includes: arranging and combining each piece of target input data corresponding to one of the two pieces of input data with each piece of target input data corresponding to the other of the two pieces of input data to obtain a plurality of target input data pairs; and inputting the plurality of target input data pairs respectively into the multiplier to obtain a plurality of output results outputted by the multiplier, and taking the plurality of output results as the preliminary operation result; each of the output results corresponding to each of the target input data pairs.

Finally, the determining truncation bit widths corresponding to the two pieces of input data, and processing the preliminary operation result according to the truncation bit widths, to obtain a multiplication operation result corresponding to the two pieces of input data includes: determining a packet truncation bit width according to data bit widths of two pieces of target input data in each of the target input data pairs as the truncation bit widths corresponding to the two pieces of input data to obtain a plurality of packet truncation bit widths for the plurality of target input data pairs; performing low-bit truncation and reservation on each output result corresponding to each target input data pair in the preliminary operation result according to each of the packet truncation bit widths corresponding to the same target input data pair respectively; and accumulating output results after the low-bit truncation and reservation to obtain the multiplication operation result corresponding to the two pieces of input data.

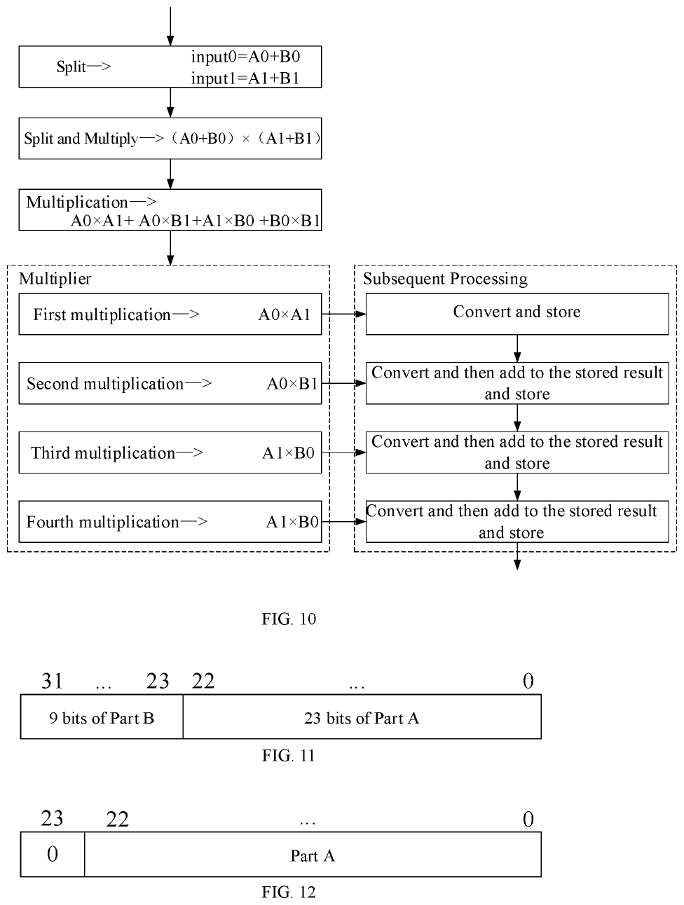

Optionally, take an 24-bit integer multiplier as an example. When the two pieces of input data (input0 and input1) are single-precision integers, since the single-precision integers are 32-bit signed or unsigned numbers and 32 is greater than a bit width 24 of the multiplier, the single-precision integers are required to be multiplied multiple times and then accumulated to finally output a 64-bit integer. A processing flow is shown in FIG. 10.

As shown in FIG. 11, firstly, the number is split into high 9 bits and low 23 bits, which are respectively called Part B and Part A. It is to be noted that Part A has to be an unsigned number, while Part B may be an unsigned number or a signed number, which is consistent with the original number.

Next, the split multiplication is split into 4 multiplications and 3 additions, and then a final result is outputted. The additions are accumulation operations and completed in a subsequent processing unit. Part A and Part B are processed separately prior to the multiplication. A processing result of Part A is shown in FIG. 12.

If Part B is a signed number, the sign bit is complemented. Otherwise, 0 is complemented. A processing result of Part B is shown in FIG. 13.

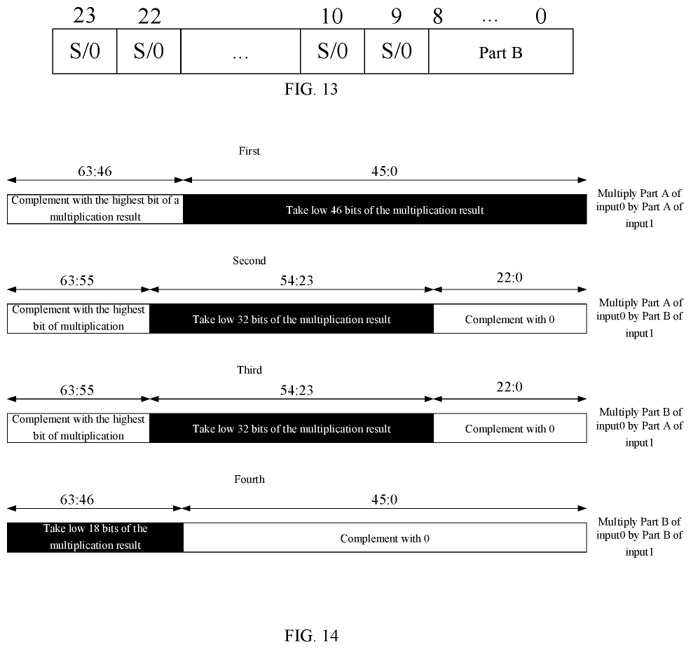

Then, a result after the multiplication is processed into a 64-bit number, which proceeds to subsequent processing for accumulation, and 64 bits are retained for an accumulation result. A processing method for the multiplication operation result each time is shown in FIG. 14.

For example,
input0 is 100000000_10000000000000000000000, and
input1 is 010000000_01000000000000000000000.

If the two are signed numbers,
Part A of input0 is 10000000000000000000000,
which is processed as 0_10000000000000000000000 prior to the multiplication.
Part B of input0 is 100000000, which is processed as 111111111111111_100000000 prior to the multiplication.
Part A of input1 is 01000000000000000000000,
which is processed as 0_01000000000000000000000 prior to the multiplication.
Part B of input1 is 010000000, which is processed as 000000000000000_010000000 prior to the multiplication.

First multiplication is 0_10000000000000000000000 multiplied by 0_01000000000000000000000, a result is 000010 . . . 0 (43 zeros), then low 46 bits of the result are taken and0010 . . . 0 (43 zeros) is obtained. The highest bit is 0, and then 0 is complemented in front to form 64 bits for storage.

Second multiplication is 0_10000000000000000000000 multiplied by 000000000000000_010000000, a result is 0 . . . 010 . . . 0 (29 zeros), then low 32 bits of the result are taken and0010 . . . 0 (29 zeros) is obtained. The highest bit is 0, and then 0 is complemented in front and in back to become 0 . . . 0 (11 zeros)10 . . . 0(52 zeros), and then be added to 0 . . . 0 (20 zeros)10 . . . 0(43 zeros) for storage.

Third multiplication is 0_10000000000000000000000 multiplied by 111111111111111_01000000000000000000000, a result is . . . 1110 . . . 0 (29 zeros), then low 32 bits are taken and 1110 . . . 0 (29 zeros) is obtained. The highest bit is 1, and then 1 is complemented in front and 0 is complemented in back to become 1 . . . 1(12 ones)0 . . . 0(52 zeros) for accumulation.

Fourth multiplication is 000000000000000_010000000 multiplied by 111111111111111_100000000, a result is . . . 1110 . . . 0 (15 zeros), then low 32 bits are taken and 1110 . . . 0 (15 zeros) is obtained. The highest bit is 1, and then 1 is complemented in front and 0 is complemented in back to become 1 . . . 1(39 ones)0 . . . 0(15 zeros) for accumulation to obtain a final multiplication operation result.

In this embodiment, when the data bit widths of the two pieces of input data are greater than the input bit width of the multiplier, only one multiplier is used to process the multiplication operation of the two pieces of input data, which can reduce resource consumption of the device for processing the multiplication operation, thereby improving the performance of the device.

In an embodiment, the performing, by using the target data conversion algorithm, data format conversion on the two pieces of input data to obtain at least two pieces of target input data further includes: performing, by using the target data conversion algorithm, data format conversion on the two pieces of input data respectively to obtain two pieces of target input data if the data bit widths of the two pieces of input data are no greater than the input bit width of the multiplier.

Further, the processing, by using a multiplier, the at least two pieces of target input data to obtain a preliminary operation result further includes: inputting the two pieces of target input data into the multiplier to obtain one output result outputted by the multiplier, and taking the output result as the preliminary operation result.

Finally, the determining truncation bit widths corresponding to the two pieces of input data, and processing the preliminary operation result according to the truncation bit widths, to obtain a multiplication operation result corresponding to the two pieces of input data further includes: adding the data bit widths of the two pieces of input data to obtain the truncation bit widths corresponding to the two pieces of input data; and performing low-bit truncation and reservation on the preliminary operation result according to the truncation bit widths, to obtain the multiplication operation result corresponding to the two pieces of input data.

In a feasible implementation, for example, the 24-bit integer multiplier is selected. When the two pieces of input data (input0 and input1) are half-precision floating-point numbers, in order to realize multiplication of the floating-point numbers, firstly, there is a need to complement the mantissa as 1.mantissa or 0.mantissa according to whether the number is normal or denormal. In the case of the two pieces of input data are the half-precision floating-point numbers, the mantissa is 10 bits, and the final multiplied number is an 11-bit unsigned integer. The 11-bit number is put into the low bits of the 24-bit input, and then the remaining bits are complemented with 0. As shown in FIG. 15, x denotes 0 or 1, which is determined according to whether to be a normal number. An unsigned number mode is selected for the multiplier. Low 22 bits are truncated and reserved as output.

For example,
input0 is 0_00000_1111111111, and
input1 is 1_01010_0000000000.
input0 is a denorm number, the mantissa thereof is 1111111111, and then the input thereof is 0000000000000_01111111111.
input0 is a normal number, the mantissa thereof is 0000000000, and then the input thereof is 0000000000000_10000000000.

Low 22 bits are truncated and reserved after multiplication of the two numbers.

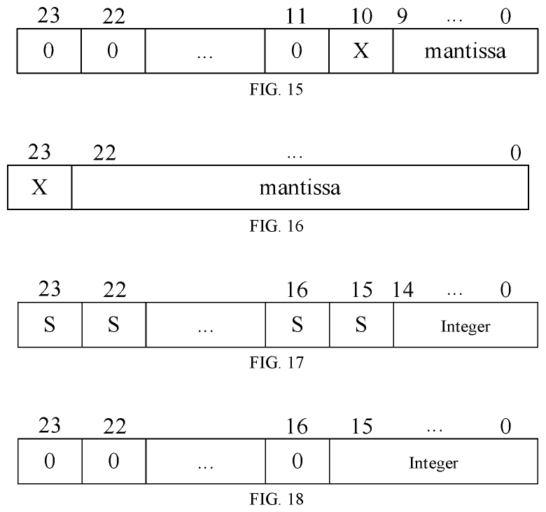

In another feasible implementation, for example, the 24-bit integer multiplier is selected. When the two pieces of input data (input0 and input1) are single-precision floating-point numbers, in order to realize multiplication of the floating-point numbers, firstly, there is a need to complement the mantissa as 1.mantissa or 0.mantissa according to whether the number is normal or denormal. In the case of the single-precision floating-point number, the mantissa is 23 bits, and the final multiplied number is a 24-bit unsigned integer, which corresponds to the bit width of the multiplier. As shown in FIG. 16, x denotes 0 or 1, which is determined according to whether to be a normal number. An unsigned number mode is selected for the multiplier. All bits are reserved as output.

For example,
input0 is 0_00000000_11111111111111111111111, and
input1 is 0_10101010_000000000000000000000000.
input0 is a denorm number, the mantissa thereof is 11111111111111111111111,
and then the input thereof is 011111111111111111111111.
input0 is a normal number, the mantissa thereof is 000000000000000000000000,
and then the input thereof is 1000000000000000000000000.

The two numbers are multiplied.

In another feasible implementation, for example, the 24-bit integer multiplier is selected. When the two pieces of input data (input0 and input1) are half-precision integers, the half-precision integers are 16-bit signed or unsigned numbers, which are placed in low bits of the 24-bit number, and the remaining bits are complemented with 0 in the case of the signed number, as shown in FIG. 17. Otherwise, the sign bit is complemented, as shown in FIG. 18. Low 32 bits are reserved as output.

For example,
input0 is 101111111111111, and
input1 is 0111111111111111.

If the two are signed numbers,
input0 produces an input of 111111111_1011111111111111, and
input1 produces an input of 000000000_0111111111111111.

If the two are unsigned numbers,
input0 produces an input of 000000000_1011111111111111, and
input1 produces an input of 000000000_0111111111111111.

It is impossible that one is an unsigned number and there other is a signed number.

Low 32 bits are truncated and reserved after multiplication of the two numbers.

In another feasible implementation, for example, the 24-bit integer multiplier is selected. When the two pieces of input data (input0 and input1) are 24-bit integers, there is no need to process input and output. When the input is a signed number, the multiplier selects the signed mode. Otherwise, the unsigned mode is selected.

In this embodiment, when the data bit widths of the two pieces of input data are no greater than the input bit width of the multiplier, only one multiplier is used to process the multiplication operation of the two pieces of input data, which can reduce resource consumption of the device for processing the multiplication operation, thereby improving the performance of the device.

In an embodiment, a data processing method includes:
determining a target data format; determining, according to a conversion relationship between each data format and the target data format, a data conversion algorithm for converting each data format into the target data format, to obtain the plurality of preset data conversion algorithms for different data formats; and determining an adaptive multiplier according to the target data format.

Data formats of two pieces of input data are acquired, and the data formats of the two pieces of input data are the same.

A target data conversion algorithm matching the data formats is determined from a plurality of preset data conversion algorithms.

Sign types of the two pieces of input data are determined, and the sign types are classified into a signed type and an unsigned type. The multiplier is configured as a signed multiplier if one of the two pieces of input data is of the signed type. The multiplier is configured an unsigned multiplier if both the two pieces of input data are of the unsigned type.

Data bit widths of the two pieces of input data are acquired, and an input bit width of the multiplier is acquired.

Each piece of input data is split into a plurality of pieces of sub-data if the data bit widths of the two pieces of input data are greater than the input bit width of the multiplier. Each of data bit widths of the plurality of pieces of sub-data is less than the input bit width of the multiplier. Data format conversion is performed, by using the target data conversion algorithm, on the plurality of pieces of sub-data to obtain a plurality of pieces of target input data. Each piece of target input data corresponding to one of the two pieces of input data is arranged and combined with each piece of target input data corresponding to the other of the two pieces of input data to obtain a plurality of target input data pairs. The plurality of target input data pairs is inputted respectively into the multiplier to obtain a plurality of output results outputted by the multiplier, and the plurality of output results are taken as the preliminary operation result. Each of the output results corresponds to each of the target input data pairs. A packet truncation bit width are determined according to data bit widths of two pieces of target input data in each of the target input data pairs as the truncation bit widths corresponding to the two pieces of input data to obtain a plurality of packet truncation bit widths for the plurality of target input data pairs. Low-bit truncation and reservation is performed on each output result in the preliminary operation result corresponding to each target input data pair according to each of the packet truncation bit widths corresponding to the same target input data pair respectively. Output results after the low-bit truncation and reservation are accumulated to obtain the multiplication operation result corresponding to the two pieces of input data.

Data format conversion is performed, by using the target data conversion algorithm, on the two pieces of input data respectively to obtain two pieces of target input data if the data bit widths of the two pieces of input data are no greater than the input bit width of the multiplier. The two pieces of target input data are inputted into the multiplier to obtain one output result outputted by the multiplier, and the output result is taken as the preliminary operation result. The data bit widths of the two pieces of input data are added to obtain the truncation bit widths corresponding to the two pieces of input data. Low-bit truncation and reservation is performed on the preliminary operation result according to the truncation bit widths, to obtain the multiplication operation result corresponding to the two pieces of input data.

It should be understood that, although the steps in the flowcharts involved in the embodiments as described above are displayed in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts involved in the embodiments as described above may include a plurality of steps or a plurality of stages, and such steps or stages are not necessarily performed at a same moment, and may be performed at different moments. The steps or stages are not necessarily performed in sequence, and the steps or stages and at least some of other steps or steps or stages of other steps may be performed in turn or alternately.

Based on a same inventive concept, an embodiment of the present application further provides a multiplier structure for implementing the data processing method described above. The implementation solution to the problem provided by the multiplier structure is similar to the implementation solution described in the method above. Therefore, the specific limitation in one or more embodiments of the multiplier structure provided below may be obtained with reference to the limitation on the data processing method above. Details are not described herein again.

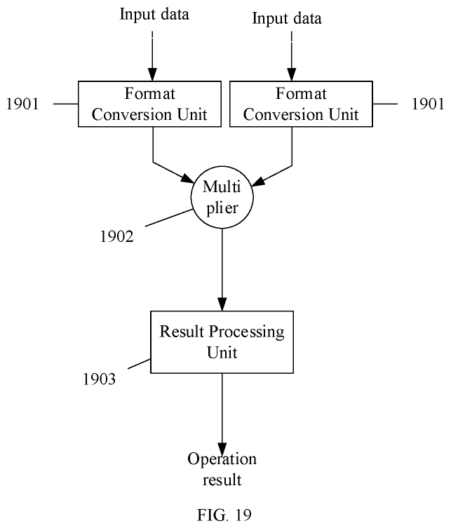

In an embodiment, as shown in FIG. 19, a multiplier structure is provided, including a format conversion unit 1901, a multiplier 1902, and a result processing unit 1903.

The format conversion unit 1901 is configured to input two pieces of input data, acquire data formats of the two pieces of input data, determine a target data conversion algorithm matching the data formats from a plurality of preset data conversion algorithms, perform, by using the target data conversion algorithm, data format conversion on the two pieces of input data to obtain at least two pieces of target input data, and input the at least two pieces of target input data into a multiplier; the data formats of the two pieces of input data being the same.

The multiplier 1902 is configured to process the at least two pieces of target input data to obtain a preliminary operation result.

The result processing unit 1903 is configured to determine truncation bit widths corresponding to the two pieces of input data, and process the preliminary operation result according to the truncation bit widths, to obtain a multiplication operation result corresponding to the two pieces of input data.

In an embodiment, the format conversion unit 1901 is further configured to determine a target data format; and determine, according to a conversion relationship between each data format and the target data format, a data conversion algorithm for converting each data format into the target data format, to obtain the plurality of preset data conversion algorithms for different data formats.

In an embodiment, the format conversion unit 1901 is further configured to acquire data bit widths of the two pieces of input data, and acquire an input bit width of the multiplier; split each piece of input data into a plurality of pieces of sub-data if the data bit widths of the two pieces of input data are greater than the input bit width of the multiplier; each data bit widths of the plurality of pieces of sub-data being less than the input bit width of the multiplier; and perform, by using the target data conversion algorithm, data format conversion on the plurality of pieces of sub-data to obtain a plurality of pieces of target input data.

In an embodiment, the multiplier 1902 is further configured to arrange and combine each piece of target input data corresponding to one of the two pieces of input data with each piece of target input data corresponding to the other of the two pieces of input data to obtain a plurality of target input data pairs; and input the plurality of target input data pairs respectively into the multiplier to obtain a plurality of output results outputted by the multiplier, and take the plurality of output results as the preliminary operation result; each of the output results corresponding to each of the target input data pairs.

In an embodiment, the result processing unit 1903 is further configured to determine a packet truncation bit width according to data bit widths of two pieces of target input data in each of the target input data pairs as the truncation bit widths corresponding to the two pieces of input data to obtain a plurality of packet truncation bit widths for the plurality of target input data pairs; perform low-bit truncation and reservation on each output result corresponding to each target input data pair in the preliminary operation result according to each of the packet truncation bit widths corresponding to the same target input data pair respectively; and accumulate output results after the low-bit truncation and reservation to obtain the multiplication operation result corresponding to the two pieces of input data.

In an embodiment, the format conversion unit 1901 is further configured to perform, by using the target data conversion algorithm, data format conversion on the two pieces of input data respectively to obtain two pieces of target input data if the data bit widths of the two pieces of input data are no greater than the input bit width of the multiplier.

In an embodiment, the multiplier 1902 is further configured to input the two pieces of target input data into the multiplier to obtain one output result outputted by the multiplier, and take the output result as the preliminary operation result.

In an embodiment, the result processing unit 1903 is further configured to add the data bit widths of the two pieces of input data to obtain the truncation bit widths corresponding to the two pieces of input data; and perform low-bit truncation and reservation on the preliminary operation result according to the truncation bit widths, to obtain the multiplication operation result corresponding to the two pieces of input data.

In an embodiment, the multiplier 1902 is further configured to determine sign types of the two pieces of input data; the sign types being classified into a signed type and an unsigned type; configure the multiplier according to the sign types of the two pieces of input data; and process, by using the configured multiplier, the at least two pieces of target input data to obtain the preliminary operation result.

In an embodiment, the multiplier 1902 is further configured to configure the multiplier as a signed multiplier if one of the two pieces of input data is of the signed type; and configure the multiplier as an unsigned multiplier if both the two pieces of input data are of the unsigned type.

The above multiplier structure can meet a variety of calculation requirements, and there is only one core multiplication unit in the entire structure, thereby reducing the chip area and the resource consumption.

The modules in the above multiplier structure can be wholly or partially implemented by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

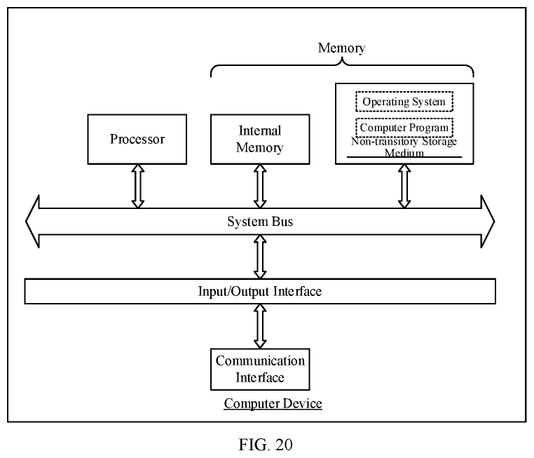

In an embodiment, a computer device is provided. The computer device may be a server, and a diagram of an internal structure thereof may be shown in FIG. 20. The computer device includes a processor, a memory, an input/output (I/O) interface, and a communication interface. The processor, the memory, and the I/O interface are connected through a system bus. The communication interface is connected to the system bus through the I/O interface. The processor of the computer device is configured to provide computing and control capabilities. The memory of the computer device includes a non-transitory storage medium and an internal memory. The non-transitory storage medium stores an operating system, a computer program, and a database. The internal memory provides an environment for running of the operating system and the computer program in the non-transitory storage medium. The database of the computer device is configured to store data of data conversion algorithms. The I/O interface of the computer device is configured to exchange information between the processor and an external device. The communication interface of the computer device is configured to communicate with an external terminal through a network connection. The computer program is executed by the processor to implement a data conversion method.

Those skilled in the art may understand that, in the structure shown in FIG. 20, only a block diagram of a partial structure related to a solution of the present application is shown, which does not constitute a limitation on the computer device to which the solution of the present application is applied. Specifically, the computer device may include more or fewer components than those shown in the figure, or some components may be combined, or a different component deployment may be used.

In an embodiment, a computer device is provided, including a memory and a processor. The memory stores a computer program. The processor, when executing the computer program, implements the following steps: acquiring data formats of two pieces of input data; the data formats of the two pieces of input data being the same; determining a target data conversion algorithm matching the data formats from a plurality of preset data conversion algorithms, and performing, by using the target data conversion algorithm, data format conversion on the two pieces of input data to obtain at least two pieces of target input data; processing, by using a multiplier, the at least two pieces of target input data to obtain a preliminary operation result; and determining truncation bit widths corresponding to the two pieces of input data, and processing the preliminary operation result according to the truncation bit widths, to obtain a multiplication operation result corresponding to the two pieces of input data.

In an embodiment, the processor, when executing the computer program, further implements the following steps: determining a target data format; determining, according to a conversion relationship between each data format and the target data format, a data conversion algorithm for converting each data format into the target data format, to obtain the plurality of preset data conversion algorithms for different data formats; and determining an adaptive multiplier according to the target data format.

In an embodiment, the processor, when executing the computer program, further implements the following steps: acquiring data bit widths of the two pieces of input data, and acquiring an input bit width of the multiplier; splitting each piece of input data into a plurality of pieces of sub-data if the data bit widths of the two pieces of input data are greater than the input bit width of the multiplier; each of data bit widths of the plurality of pieces of sub-data being less than the input bit width of the multiplier; and performing, by using the target data conversion algorithm, data format conversion on the plurality of pieces of sub-data to obtain a plurality of pieces of target input data.

In an embodiment, the processor, when executing the computer program, further implements the following steps: arranging and combining each piece of target input data corresponding to one of the two pieces of input data with each piece of target input data corresponding to the other of the two pieces of input data to obtain a plurality of target input data pairs; and inputting the plurality of target input data pairs respectively into the multiplier to obtain a plurality of output results outputted by the multiplier, and taking the plurality of output results as the preliminary operation result; each of the output results corresponding to each of the target input data pairs.

In an embodiment, the processor, when executing the computer program, further implements the following steps: determining a packet truncation bit width according to data bit widths of two pieces of target input data in each of the target input data pairs as the truncation bit widths corresponding to the two pieces of input data to obtain a plurality of packet truncation bit widths for the plurality of target input data pairs; performing low-bit truncation and reservation on each output result corresponding to each target input data pair in the preliminary operation result according to each of the packet truncation bit widths corresponding to the same target input data pair respectively; and accumulating output results after the low-bit truncation and reservation to obtain the multiplication operation result corresponding to the two pieces of input data.

In an embodiment, the processor, when executing the computer program, further implements the following step: performing, by using the target data conversion algorithm, data format conversion on the two pieces of input data respectively to obtain two pieces of target input data if the data bit widths of the two pieces of input data are no greater than the input bit width of the multiplier.

In an embodiment, the processor, when executing the computer program, further implements the following step: inputting the two pieces of target input data into the multiplier to obtain one output result outputted by the multiplier, and taking the output result as the preliminary operation result.

In an embodiment, the processor, when executing the computer program, further implements the following steps: adding the data bit widths of the two pieces of input data to obtain the truncation bit widths corresponding to the two pieces of input data; and performing low-bit truncation and reservation on the preliminary operation result according to the truncation bit widths, to obtain the multiplication operation result corresponding to the two pieces of input data.

In an embodiment, the processor, when executing the computer program, further implements the following steps: determining sign types of the two pieces of input data; the sign types being classified into a signed type and an unsigned type; configuring the multiplier according to the sign types of the two pieces of input data; and processing, by using the configured multiplier, the at least two pieces of target input data to obtain the preliminary operation result.

In an embodiment, the processor, when executing the computer program, further implements the following steps: configuring the multiplier as a signed multiplier if one of the two pieces of input data is of the signed type; and configuring the multiplier as an unsigned multiplier if both the two pieces of input data are of the unsigned type.

In an embodiment, a computer-readable storage medium is provided, storing a computer program. When the computer program is executed by a processor, the following steps are implemented: acquiring data formats of two pieces of input data; the data formats of the two pieces of input data being the same; determining a target data conversion algorithm matching the data formats from a plurality of preset data conversion algorithms, and performing, by using the target data conversion algorithm, data format conversion on the two pieces of input data to obtain at least two pieces of target input data; processing, by using a multiplier, the at least two pieces of target input data to obtain a preliminary operation result; and determining truncation bit widths corresponding to the two pieces of input data, and processing the preliminary operation result according to the truncation bit widths, to obtain a multiplication operation result corresponding to the two pieces of input data.

In an embodiment, when the computer program is executed by a processor, the following steps are further implemented: determining a target data format; determining, according to a conversion relationship between each data format and the target data format, a data conversion algorithm for converting each data format into the target data format, to obtain the plurality of preset data conversion algorithms for different data formats; and determining an adaptive multiplier according to the target data format.

In an embodiment, when the computer program is executed by a processor, the following steps are further implemented: acquiring data bit widths of the two pieces of input data, and acquiring an input bit width of the multiplier; splitting each piece of input data into a plurality of pieces of sub-data if the data bit widths of the two pieces of input data are greater than the input bit width of the multiplier; each of data bit widths of the plurality of pieces of sub-data being less than the input bit width of the multiplier; and performing, by using the target data conversion algorithm, data format conversion on the plurality of pieces of sub-data to obtain a plurality of pieces of target input data.

In an embodiment, when the computer program is executed by a processor, the following steps are further implemented: arranging and combining each piece of target input data corresponding to one of the two pieces of input data with each piece of target input data corresponding to the other of the two pieces of input data to obtain a plurality of target input data pairs; and inputting the plurality of target input data pairs respectively into the multiplier to obtain a plurality of output results outputted by the multiplier, and taking the plurality of output results as the preliminary operation result; each of the output results corresponding to each of the target input data pairs.

In an embodiment, when the computer program is executed by a processor, the following steps are further implemented: determining a packet truncation bit width according to data bit widths of two pieces of target input data in each of the target input data pairs as the truncation bit widths corresponding to the two pieces of input data to obtain a plurality of packet truncation bit widths for the plurality of target input data pairs; performing low-bit truncation and reservation on each output result corresponding to each target input data pair in the preliminary operation result according to each of the packet truncation bit widths corresponding to the same target input data pair respectively; and accumulating output results after the low-bit truncation and reservation to obtain the multiplication operation result corresponding to the two pieces of input data.

In an embodiment, when the computer program is executed by a processor, the following steps are further implemented: performing, by using the target data conversion algorithm, data format conversion on the two pieces of input data respectively to obtain two pieces of target input data if the data bit widths of the two pieces of input data are no greater than the input bit width of the multiplier.

In an embodiment, when the computer program is executed by a processor, the following steps are further implemented: inputting the two pieces of target input data into the multiplier to obtain one output result outputted by the multiplier, and taking the output result as the preliminary operation result.

In an embodiment, when the computer program is executed by a processor, the following steps are further implemented: adding the data bit widths of the two pieces of input data to obtain the truncation bit widths corresponding to the two pieces of input data; and performing low-bit truncation and reservation on the preliminary operation result according to the truncation bit widths, to obtain the multiplication operation result corresponding to the two pieces of input data.

In an embodiment, when the computer program is executed by a processor, the following steps are further implemented: determining sign types of the two pieces of input data; the sign types being classified into a signed type and an unsigned type; configuring the multiplier according to the sign types of the two pieces of input data; and processing, by using the configured multiplier, the at least two pieces of target input data to obtain the preliminary operation result.

In an embodiment, when the computer program is executed by a processor, the following steps are further implemented: configuring the multiplier as a signed multiplier if one of the two pieces of input data is of the signed type; and configuring the multiplier as an unsigned multiplier if both the two pieces of input data are of the unsigned type.

In an embodiment, a computer program product is provided, including a computer program. When the computer program is executed by a processor, the following steps are implemented: acquiring data formats of two pieces of input data; the data formats of the two pieces of input data being the same; determining a target data conversion algorithm matching the data formats from a plurality of preset data conversion algorithms, and performing, by using the target data conversion algorithm, data format conversion on the two pieces of input data to obtain at least two pieces of target input data; processing, by using a multiplier, the at least two pieces of target input data to obtain a preliminary operation result; and determining truncation bit widths corresponding to the two pieces of input data, and processing the preliminary operation result according to the truncation bit widths, to obtain a multiplication operation result corresponding to the two pieces of input data.

In an embodiment, when the computer program is executed by a processor, the following steps are further implemented: determining a target data format; determining, according to a conversion relationship between each data format and the target data format, a data conversion algorithm for converting each data format into the target data format, to obtain the plurality of preset data conversion algorithms for different data formats; and determining an adaptive multiplier according to the target data format.

In an embodiment, when the computer program is executed by a processor, the following steps are further implemented: acquiring data bit widths of the two pieces of input data, and acquiring an input bit width of the multiplier; splitting each piece of input data into a plurality of pieces of sub-data if the data bit widths of the two pieces of input data are greater than the input bit width of the multiplier; each of data bit widths of the plurality of pieces of sub-data being less than the input bit width of the multiplier; and performing, by using the target data conversion algorithm, data format conversion on the plurality of pieces of sub-data to obtain a plurality of pieces of target input data.

In an embodiment, when the computer program is executed by a processor, the following steps are further implemented: arranging and combining each piece of target input data corresponding to one of the two pieces of input data with each piece of target input data corresponding to the other of the two pieces of input data to obtain a plurality of target input data pairs; and inputting each of the plurality of target input data pairs into the multiplier to obtain a plurality of output results outputted by the multiplier, and taking the plurality of output results as the preliminary operation result; each of the output results corresponding to one of the target input data pairs.

In an embodiment, when the computer program is executed by a processor, the following steps are further implemented: determining a packet truncation bit widths according to data bit widths of two pieces of target input data in each of the target input data pairs as the truncation bit widths corresponding to the two pieces of input data to obtain a plurality of packet truncation bit widths for the plurality of target input data pairs; performing low-bit truncation and reservation on each output result corresponding to each target input data pair in the preliminary operation result according to each of the packet truncation bit widths corresponding to the same target input data pair respectively; and accumulating output results after the low-bit truncation and reservation to obtain the multiplication operation result corresponding to the two pieces of input data.

In an embodiment, when the computer program is executed by a processor, the following steps are further implemented: performing, by using the target data conversion algorithm, data format conversion on the two pieces of input data respectively to obtain two pieces of target input data if the data bit widths of the two pieces of input data are no greater than the input bit width of the multiplier.

In an embodiment, when the computer program is executed by a processor, the following steps are further implemented: inputting the two pieces of target input data into the multiplier to obtain one output result outputted by the multiplier, and taking the output result as the preliminary operation result.

In an embodiment, when the computer program is executed by a processor, the following steps are further implemented: adding the data bit widths of the two pieces of input data to obtain the truncation bit widths corresponding to the two pieces of input data; and performing low-bit truncation and reservation on the preliminary operation result according to the truncation bit widths, to obtain the multiplication operation result corresponding to the two pieces of input data.

In an embodiment, when the computer program is executed by a processor, the following steps are further implemented: determining sign types of the two pieces of input data; the sign types being classified into a signed type and an unsigned type; configuring the multiplier according to the sign types of the two pieces of input data; and processing, by using the configured multiplier, the at least two pieces of target input data to obtain the preliminary operation result.

In an embodiment, when the computer program is executed by a processor, the following steps are further implemented: configuring the multiplier as a signed multiplier if one of the two pieces of input data is of the signed type; and configuring the multiplier as an unsigned multiplier if both the two pieces of input data are of the unsigned type.

It is to be noted that user information (including, but not limited to, user equipment information, user personal information, and the like) and data (including, but not limited to, data for analysis, stored data, displayed data, and the like) involved in the present application are information and data authorized by the user or fully authorized by all parties, and collection, use, and processing of relevant data are required to comply with relevant laws, regulations, and standards of relevant countries and regions.

Those of ordinary skill in the art may understand that some or all flows in the methods in the foregoing embodiments may be implemented by a computer program instructing related hardware, the computer program may be stored in a non-transitory computer-readable storage medium, and when the computer program is executed, the flows in the foregoing method embodiments may be implemented. Any reference to the memory, the database, or other media used in the embodiments provided in the present application may include at least one of a non-transitory memory and a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, and the like. The transitory memory may include a random access memory (RAM) or an external cache memory. By way of illustration instead of limitation, the RAM is available in a variety of forms, such as a static RAM (SRAM) or a dynamic RAM (DRAM). The database involved in the embodiments provided in the present application may include at least one of a relational database and a non-relational database. The non-relational database may include a blockchain-based distributed database and the like, but is not limited thereto. The processor involved in the embodiments provided in the present application may be a general-purpose processor, a central processing unit, a graphics processor, a digital signal processor, a programmable logic device, a data processing logic device based on quantum computing, and the like, and is not limited thereto.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present application, and the description thereof is specific and detailed, but cannot therefore be understood as a limitation on the patent scope of the present application. It should be noted that those of ordinary skill in the art may further make variations and improvements without departing from the conception of the present application, and these all fall within the protection scope of the present application. Therefore, the protection scope of the present application should be subject to the appended claims.

What is claimed is:

1. A data processing method, comprising:
acquiring data formats of two pieces of input data; the data formats of the two pieces of input data being the same;
determining a target data conversion algorithm matching the data formats from a plurality of preset data conversion algorithms, and performing, by using the target data conversion algorithm, data format conversion on the two pieces of input data to obtain at least two pieces of target input data;
processing, by using a multiplier, the at least two pieces of target input data to obtain a preliminary operation result; and
determining truncation bit widths corresponding to the two pieces of input data, and processing the preliminary operation result according to the truncation bit widths, to obtain a multiplication operation result corresponding to the two pieces of input data.

2. The method according to claim 1, wherein the plurality of preset data conversion algorithms are acquired by:
determining a target data format; and
determining, according to a conversion relationship between each data format and the target data format, a data conversion algorithm for converting each data format into the target data format, to obtain the plurality of preset data conversion algorithms for different data formats; and
the multiplier is acquired by:
determining an adaptive multiplier according to the target data format.

3. The method according to claim 1, wherein performing, by using the target data conversion algorithm, data format conversion on the two pieces of input data to obtain at least two pieces of target input data comprises:
acquiring data bit widths of the two pieces of input data, and acquiring an input bit width of the multiplier;
splitting each piece of input data into a plurality of pieces of sub-data if the data bit widths of the two pieces of input data are greater than the input bit width of the multiplier;
each of data bit widths of the plurality of pieces of sub-data being less than the input bit width of the multiplier; and
performing, by using the target data conversion algorithm, data format conversion on the plurality of pieces of sub-data to obtain a plurality of pieces of target input data.

4. The method according to claim 3, wherein processing, by using the multiplier, the at least two pieces of target input data to obtain the preliminary operation result comprises:
arranging and combining each piece of target input data corresponding to one of the two pieces of input data with each piece of target input data corresponding to the other of the two pieces of input data to obtain a plurality of target input data pairs; and
inputting the plurality of target input data pairs respectively into the multiplier to obtain a plurality of output results outputted by the multiplier, and taking the plurality of output results as the preliminary operation result; each of the output results corresponding to each of the target input data pairs.

5. The method according to claim 4, wherein determining the truncation bit widths corresponding to the two pieces of input data, and processing the preliminary operation result according to the truncation bit widths, to obtain the multiplication operation result corresponding to the two pieces of input data comprises:
determining a packet truncation bit width according to data bit widths of two pieces of target input data in each of the target input data pairs as the truncation bit widths corresponding to the two pieces of input data to obtain a plurality of packet truncation bit widths for the plurality of target input data pairs;
performing low-bit truncation and reservation on each output result corresponding to each target input data pair in the preliminary operation result according to each of the packet truncation bit widths corresponding to the same target input data pair respectively; and
accumulating output results after the low-bit truncation and reservation to obtain the multiplication operation result corresponding to the two pieces of input data.

6. The method according to claim 3, wherein performing, by using the target data conversion algorithm, data format conversion on the two pieces of input data to obtain at least two pieces of target input data further comprises:
performing, by using the target data conversion algorithm, data format conversion on the two pieces of input data respectively to obtain two pieces of target input data if the data bit widths of the two pieces of input data are no greater than the input bit width of the multiplier.

7. The method according to claim 6, wherein processing, by using the multiplier, the at least two pieces of target input data to obtain the preliminary operation result further comprises:
inputting the two pieces of target input data into the multiplier to obtain one output result outputted by the multiplier, and taking the output result as the preliminary operation result.

8. The method according to claim 6, wherein determining truncation bit widths corresponding to the two pieces of input data, and processing the preliminary operation result according to the truncation bit widths, to obtain the multiplication operation result corresponding to the two pieces of input data further comprises:
adding the data bit widths of the two pieces of input data to obtain the truncation bit widths corresponding to the two pieces of input data; and
performing low-bit truncation and reservation on the preliminary operation result according to the truncation bit widths, to obtain the multiplication operation result corresponding to the two pieces of input data.

9. The method according to claim 1, further comprising:
determining sign types of the two pieces of input data; the sign types being classified into a signed type and an unsigned type;
configuring the multiplier according to the sign types of the two pieces of input data; and
processing, by using the configured multiplier, the at least two pieces of target input data to obtain the preliminary operation result.

10. The method according to claim 9, wherein configuring the multiplier according to the sign types of the two pieces of input data comprises:
configuring the multiplier as a signed multiplier if one of the two pieces of input data is of the signed type; and
configuring the multiplier as an unsigned multiplier if both the two pieces of input data are of the unsigned type.

11. A computer device, comprising a memory and a processor, the memory storing a computer program, wherein the processor, when executing the computer program, implements the following steps:
acquiring data formats of two pieces of input data; the data formats of the two pieces of input data being the same;
determining a target data conversion algorithm matching the data formats from a plurality of preset data conversion algorithms, and performing, by using the target data conversion algorithm, data format conversion on the two pieces of input data to obtain at least two pieces of target input data;
processing, by using a multiplier, the at least two pieces of target input data to obtain a preliminary operation result; and
determining truncation bit widths corresponding to the two pieces of input data, and processing the preliminary operation result according to the truncation bit widths, to obtain a multiplication operation result corresponding to the two pieces of input data.

12. The computer device of claim 11, wherein the plurality of preset data conversion algorithms are acquired by:
determining a target data format; and
determining, according to a conversion relationship between each data format and the target data format, a data conversion algorithm for converting each data format into the target data format, to obtain the plurality of preset data conversion algorithms for different data formats; and
the multiplier is acquired by:
determining an adaptive multiplier according to the target data format.

13. The computer device of claim 11, wherein performing, by using the target data conversion algorithm, data format conversion on the two pieces of input data to obtain at least two pieces of target input data comprises:
acquiring data bit widths of the two pieces of input data, and acquiring an input bit width of the multiplier;
splitting each piece of input data into a plurality of pieces of sub-data if the data bit widths of the two pieces of input data are greater than the input bit width of the multiplier;
each of data bit widths of the plurality of pieces of sub-data being less than the input bit width of the multiplier; and
performing, by using the target data conversion algorithm, data format conversion on the plurality of pieces of sub-data to obtain a plurality of pieces of target input data.

14. The computer device of claim 13, wherein processing, by using the multiplier, the at least two pieces of target input data to obtain the preliminary operation result comprises:
arranging and combining each piece of target input data corresponding to one of the two pieces of input data with each piece of target input data corresponding to the other of the two pieces of input data to obtain a plurality of target input data pairs; and
inputting the plurality of target input data pairs respectively into the multiplier to obtain a plurality of output results outputted by the multiplier, and taking the plurality of output results as the preliminary operation result; each of the output results corresponding to each of the target input data pairs;
wherein determining the truncation bit widths corresponding to the two pieces of input data, and processing the preliminary operation result according to the truncation bit widths, to obtain the multiplication operation result corresponding to the two pieces of input data comprises:
determining a packet truncation bit width according to data bit widths of two pieces of target input data in each of the target input data pairs as the truncation bit widths corresponding to the two pieces of input data to obtain a plurality of packet truncation bit widths for the plurality of target input data pairs;
performing low-bit truncation and reservation on each output result corresponding to each target input data pair in the preliminary operation result according to each of the packet truncation bit widths corresponding to the same target input data pair respectively; and
accumulating output results after the low-bit truncation and reservation to obtain the multiplication operation result corresponding to the two pieces of input data.

15. The computer device of claim 13, wherein performing, by using the target data conversion algorithm, data format conversion on the two pieces of input data to obtain at least two pieces of target input data further comprises:
performing, by using the target data conversion algorithm, data format conversion on the two pieces of input data respectively to obtain two pieces of target input data if the data bit widths of the two pieces of input data are no greater than the input bit width of the multiplier.

16. The computer device of claim 15, wherein processing, by using the multiplier, the at least two pieces of target input data to obtain the preliminary operation result further comprises:
inputting the two pieces of target input data into the multiplier to obtain one output result outputted by the multiplier, and taking the output result as the preliminary operation result.

17. The computer device of claim 15, wherein determining truncation bit widths corresponding to the two pieces of input data, and processing the preliminary operation result according to the truncation bit widths, to obtain the multiplication operation result corresponding to the two pieces of input data further comprises:
adding the data bit widths of the two pieces of input data to obtain the truncation bit widths corresponding to the two pieces of input data; and
performing low-bit truncation and reservation on the preliminary operation result according to the truncation bit widths, to obtain the multiplication operation result corresponding to the two pieces of input data.

18. The computer device of claim 11, wherein the processor, when executing the computer program, further implements the following steps:
determining sign types of the two pieces of input data; the sign types being classified into a signed type and an unsigned type;
configuring the multiplier according to the sign types of the two pieces of input data; and
processing, by using the configured multiplier, the at least two pieces of target input data to obtain the preliminary operation result.

19. The computer device of claim 18, wherein configuring the multiplier according to the sign types of the two pieces of input data comprises:
configuring the multiplier as a signed multiplier if one of the two pieces of input data is of the signed type; and
configuring the multiplier as an unsigned multiplier if both the two pieces of input data are of the unsigned type.

20. A non-transitory computer-readable storage medium, storing a computer program, wherein steps of the method according to claim 1 are implemented when the computer program is executed by a processor.
